(19) United States
(12) Patent Application Publication
(10) Pub. No.: US 2026/0327489 A1
(43) Pub. Date: Oct. 22, 2026

(54) INFRARED-ABSORBING QUANTUM DOT, AND METHOD FOR PRODUCING INFRARED-ABSORBING QUANTUM DOT

(71) Applicant: SHOEI CHEMICAL INC., Tokyo (JP)

(72) Inventors: Kenzaburo SUGIMOTO, Corvallis, OR (US); Ercan BAYRAM, Corvallis, OR (US); Thomas NOVET, Corvallis, OR (US)

(21) Appl. No.: 19/099,443

(22) PCT Filed: Jun. 9, 2023
(86) PCT No.: PCT/JP2023/021528

§ 371 Date: Jan. 28, 2025

Related U.S. Application Data
(60) Provisional application No. 63/369,804, filed on Jul. 29, 2022.

(51) Int. Cl. C09K 11/88; B82Y 30/00; B82Y 40/00; C09K 113/00

(52) U.S. Cl. CPC C09K 11/881; B82Y 30/00; B82Y 40/00; C09K 2113/00

(57) ABSTRACT

The infrared-absorbing quantum dot in accordance with an embodiment of the invention is an infrared-absorbing quantum dot, comprising: silver (Ag); and tellurium (Te); wherein the infrared-absorbing quantum dot comprises an absorbance peak in the range of 1400 nm-1800 nm, and wherein a peak:valley ratio (p/v) of the absorbance peak is greater than or equal to 1.0.

### TECHNICAL FIELD

This invention relates to infrared-absorbing quantum dots and production methods for infrared-absorbing quantum dots. This present application claims the benefit of priority from U.S. Provisional Patent Application Ser. No. 63/369,804, filed on Jul. 29, 2022, and the entire content of which is incorporated herein by reference.

### BACKGROUND ART

Many optoelectronic devices, such as photovoltaic devices, telecommunication devices, sensor devices, as well as in-vivo bioimaging materials, employ materials that absorb light in an infrared (IR) region of the electromagnetic spectrum. In some instances, it may be advantageous to utilize materials with an absorbance peak in the range of over 1400 nm. This may increase a signal-to-noise ratio of the light absorbed by a device. For example, this region overlaps with emission peaks of IR light sources (e.g., a 1450-nm laser).

### CITATION LIST

### Non-Patent Literature

[Non-patent literature 1] Zhen-Ya Liu, et al., “Breaking through the Size Control Dilemma of Silver Chalcogenide Quantum Dots via Trialkylphosphine-Induced Ripening: Leading to Ag2Te Emitting from 950 to 2100 nm” Journal of the American Chemical Society, vol. 143, issue 32, 2021, pp 12867-12877
[Non-patent literature 2] Jianying Ouyang, et al., “Ag2Te Colloidal Quantum Dots for Near-Infrared-II Photodetectors” ACS Applied Nano Materials, vol. 4, issue 12, 2021, pp 13587-13601

### SUMMARY OF INVENTION

### Technical Problem

In some instances, single-crystal semiconductors such as gallium arsenide is utilized as an infrared-absorbing (IR-absorbing) material. However, it can be challenging to manufacture some devices using single-crystal semiconductor. For example, a detector for an IR camera may include an array of pixels, each of which comprises single-crystal semiconductor placed on a silicon backplane. However, cutting the single-crystal semiconductor into portions corresponding to the pixels and placing each portion onto a backplane of the array may be technologically difficult, costly, and time-consuming. Furthermore, it can be challenging to fabricate silicon-based detectors that selectively absorb light in the range of over 1400 nm.

In other instances, quantum dots (QDs) may be used to absorb IR light. For example, lead based QDs, cadmium-based QDs, and mercury-based QDs may absorb strongly in the range of 1400-1500 nm. However, QDs based on heavy metals can be challenging to use in biological and medical applications. Heavy metals may also pose environmental hazards upon disposal.

As introduced above, quantum dots (hereinafter referred to as QDs) based on heavy metals, such as lead, cadmium, and mercury, may absorb strongly in the range of over 1400 nm. However, heavy-metal-based QDs may pose environmental and health hazards. Conventional silver chalcogenides (e.g., Ag₂S, Ag₂Se, and Ag₂Te) QDs may be used as a less-toxic alternative to heavy-metal-based QDs. However, silver chalcogenides QDs may have a shorter absorption peak wavelength (e.g., less than 1400 nm), a larger half-width-half-maximum (HWHM) of the absorption peak, and/or a smaller peak-valley ratio (e.g., less than 1.0) than heavy-metal-based QDs (e.g., PbS). This may result in poor absorption at a target wavelength (e.g., in the range of 1400-1800 nm) and/or a smaller or undetectable signal-to-noise ratio relative to the use of heavy-metal-based QDs.

Therefore, the purpose of this invention is to provide quantum dots that can absorb infrared light at or above 1400 nm and are substantially free of heavy metals.

### Solution to Problem

The infrared-absorbing quantum dot in accordance with an embodiment of the invention is an infrared-absorbing quantum dot, comprising: silver (Ag); and tellurium (Te); wherein the infrared-absorbing quantum dot comprises an absorbance peak in the range of 1400 nm-1800 nm, and wherein a peak:valley ratio (p/v) of the absorbance peak is greater than or equal to 1.0.

The method for preparing infrared-absorbing quantum dots in accordance with the embodiments of the invention is a method for preparing infrared-absorbing quantum dots in accordance with the above embodiments of the invention, comprising:
Nucleating a quantum dot seed comprising silver (Ag) and tellurium (Te); and
adding a chalcogenide precursor to grow the quantum dot seed to thereby form an infrared-absorbing quantum dot having an absorbance peak in the range of 1400 nm-1800 nm,
wherein a peak:valley ratio (p/v) of the peak is greater than or equal to 1.0, and wherein the chalcogenide precursor includes tellurium (Te).

The infrared-absorbing quantum dot in accordance with another embodiment of the invention is an infrared-absorbing quantum dot, comprising:
a core including silver (Ag) and tellurium (Te); and
a shell including silver (Ag), tellurium (Te), and selenium (Se),
wherein the infrared-absorbing quantum dot comprises an absorbance peak in the range of 1400 nm-1800 nm, and wherein a peak:valley ratio (p/v) of the peak is greater than or equal to 1.0.

### Advantageous Effect of the Invention

According to an embodiment of the invention, quantum dots that can absorb infrared light at or above 1400 nm and are substantially free of heavy metals can be provided.

### DESCRIPTION OF DRAWINGS

FIG. 1 shows an example of an infrared-absorbing quantum dot comprising silver and tellurium according to an example embodiment of the present disclosure.

FIG. 2 shows a transmission electron microscope (TEM) image of a plurality of infrared-absorbing quantum dots comprising silver and tellurium according to an example embodiment of the present disclosure.

FIG. 3 shows a plot of absorbance spectra for a plurality of infrared-absorbing quantum dot populations formed using different silver/telluride molar ratios according to an example embodiment of the present disclosure.

FIG. 4 shows another example of an infrared-absorbing quantum dot comprising silver, tellurium, and selenium according to another example embodiment of the present disclosure.

FIG. 5 shows a TEM image of a plurality of infrared-absorbing quantum dots comprising silver, tellurium, and selenium according to an example embodiment of the present disclosure.

FIG. 6 shows a plot of absorbance spectra for example populations of infrared-absorbing quantum dots comprising Se—Te shells.

FIG. 7 shows an X-ray fluorescence spectrum for a sample of infrared-absorbing quantum dots according to an example embodiment of the present disclosure.

FIG. 8 shows a flowchart of an example method for preparing infrared-absorbing quantum dots according to an example embodiment of the present disclosure.

### DESCRIPTION OF DRAWINGS

Disclosed herein are examples that relate to an infrared (IR)-absorbing QD comprising silver (Ag) and tellurium (Te) and methods for producing same. The IR-absorbing QD comprises an absorbance peak in the range of 1400 nm-1800 nm with a peak:valley ratio (p/v) than greater or equal to 1.0. Advantageously, the IR-absorbing QD is substantially free of heavy metal elements. The term “substantially free of heavy metal elements” may generally refer to a quantum dot that has no heavy metal elements other than potential trace impurities present in the reactants used to make the quantum dot.

This Summary is provided in order to introduce in simplified form a selection of concepts that are further described in the Detailed Description. The Summary is not intended to identify key features or essential features of the claimed subject matter, nor is it intended to be used to limit the scope of the claimed subject matter.

FIG. 1 shows an example of an IR-absorbing QD 100. As illustrated by way of example in FIG. 1, the IR-absorbing QD 100 is formed in a two-step (e.g., seeded growth) process, in which a QD seed 102 is nucleated using a silver precursor 104 and a chalcogenide precursor 106, and additional chalcogenide precursor 106 is then added to grow the quantum dot seed to thereby form the IR-absorbing QD 100.

The QD seed 102 comprises silver and tellurium. For example, the QD seed 102 may take the form of Ag—Te. In some examples, the QD seed is nucleated using a hot injection method. In the hot-injection method, the chalcogenide precursor 106 is quickly added to a hot (e.g., 150° C.) solution of the silver precursor 104. The silver precursor 104 and the chalcogenide precursor 106 may comprise any suitable materials. One example of a suitable chalcogenide precursor 106 includes trioctylphosphine telluride (TOPTe). One example of a suitable silver precursor 104 includes silver acetate. Any suitable solvent may be used for the reaction. In some examples, the silver acetate may be dissolved in octanethiol.

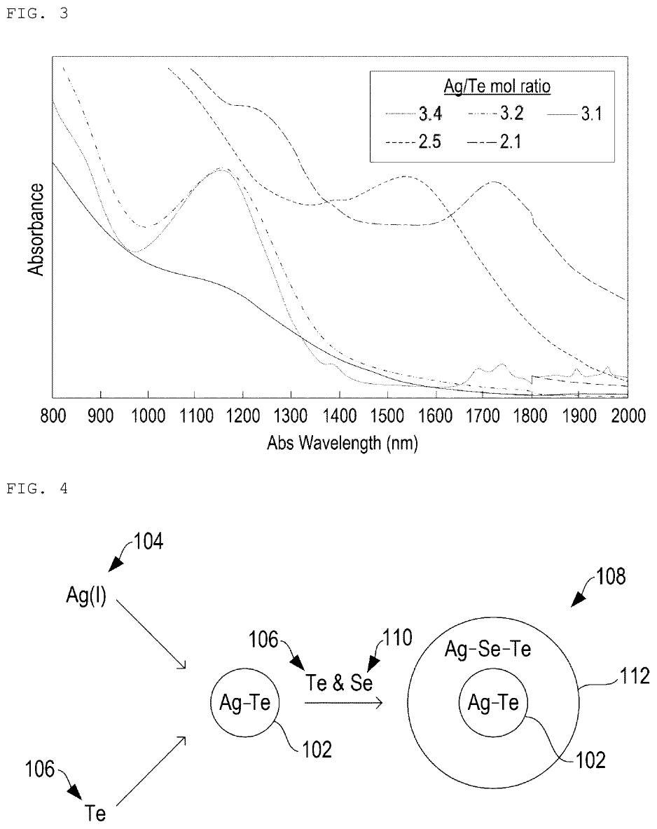

In some examples, the chalcogenide precursor 106 is added to a solution comprising excess silver. This enables the quantity of the chalcogenide precursor 106 to control size and dispersion of the resulting QD seeds, as well as a stoichiometric ratio of silver and tellurium in the solution. The Ag:Te molar ratio (Ag/Te) is described in more detail below with reference to FIG. 3.

In some examples, the QD seeds 102 are grown for up to 1 hour in the reaction mixture. For example, the QD seeds 102 may be grown for 40 min. In other examples, the QD seeds 102 are grown for greater than 1 hour. In some examples, the QD seeds 102 are grown at a temperature in the range of 80-200° C. In other examples, the QD seeds 102 are grown at a temperature in the range of 120-180° C. In yet other examples, the QD seeds 102 are grown at a temperature in the range of 140-160° C. At longer reaction times, the absorbance peak shifts to longer wavelengths, but also may yield smaller peak:valley ratios (p/v). Without wishing to be bound by theory, this may be due to particle growth occurring at different times and/or rates, resulting in a wider range of particle sizes and corresponding broader absorbance peaks. This may additionally or alternatively be due to loss of ligand coverage around the infrared-absorbing QDs.

The QD seeds 102 are used as a foundation to grow the IR-absorbing QD 100. Referring again to FIG. 1, additional chalcogenide precursor 106 is added to the reaction mixture containing the QD seeds 102. In some examples, the growth of the QD seeds 102 is quenched before the chalcogenide precursor 106 is added. For example, the reaction mixture containing the QD seeds 102 may be cooled to ambient temperature (e.g., 25° C.) after reacting at the growth temperature (e.g., 40 minutes at 150° C.). Quenching may prevent uneven growth and agglomeration of the QD seeds 102. In other examples, the chalcogenide precursor 106 is added to the reaction mixture without quenching the growth of the QD seeds 102. For example, quenching may be omitted when the additional chalcogenide precursor used to grow the IR-absorbing QD 100 from the QD seed 102 is substantially the same as the chalcogenide precursor used to form the QD seed 102.

As introduced above, in some examples, the IR-absorbing QD 100 is formed by adding an additional quantity of the chalcogenide precursor 106 to the reaction mixture containing the QD seed 102. In some examples, additional TOPTe is added to the reaction mixture containing the QD seed 102. In some examples, the reaction mixture is heated for up to 1 additional hour. For example, the reaction mixture may be heated for 40 minutes to grow the IR-absorbing QD 100 from the QD seed 102. In other examples, the reaction mixture is heated for greater than 1 hour.

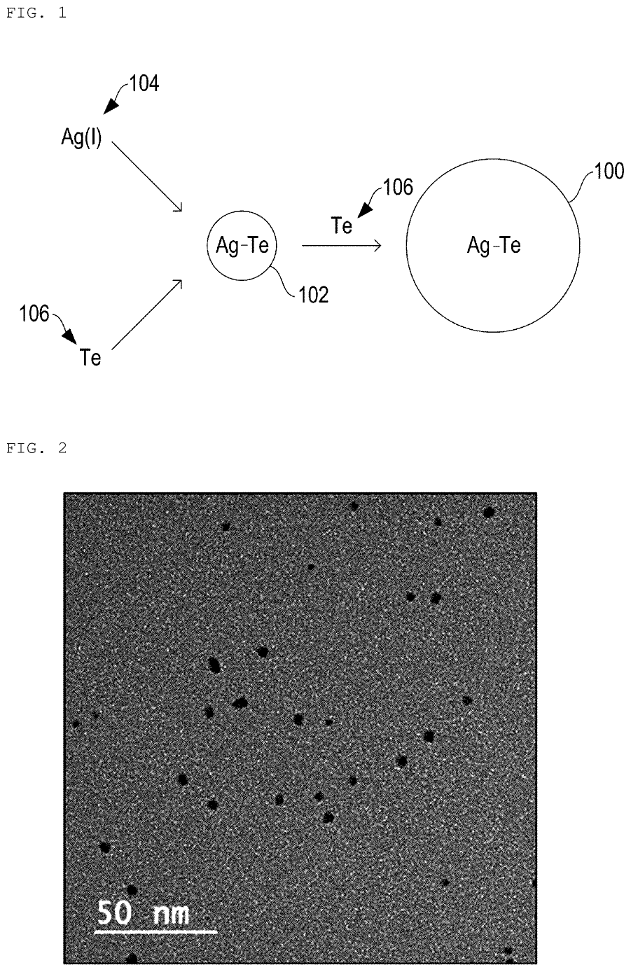

In some examples, the IR-absorbing QD 100 is grown at a temperature in the range of 80-200° C. In other examples, the IR-absorbing QD 100 is grown at a temperature in the range of 120-180° C. In yet other examples, the IR-absorbing QD 100 is grown at a temperature in the range of 140-160° C. Growing the IR-absorbing QD 100 from the QD seed 102 enables the IR-absorbing QD 100 to be formed with a distinct absorbance peak (e.g., having a peak:valley ratio (p/v)≥1.0) in the range of 1400 nm-1800 nm, which is challenging to achieve via a single-step process. FIG. 2 shows a transmission electron microscopy (TEM) image of Ag—Te IR-absorbing QDs prepared as described herein.

The additional quantity of the chalcogenide precursor 106 is added to achieve a suitable molar ratio of Ag:Te (Ag/Te) in the IR-absorbing QD 100. In some examples, the IR-absorbing QD 100 comprises a molar ratio of Ag:Te (Ag/Te) in the range of 2-6. In other examples, the IR-absorbing QD 100 comprises a molar ratio of Ag:Te (Ag/Te) in the range of 2.1-5.8. In yet other examples, the IR-absorbing QD 100 comprises a molar ratio of Ag:Te (Ag/Te) in the range of 2.1-2.7. Here, the molar ratio of Ag:Te (Ag/Te) can be calculated by ICP emission analysis.

FIG. 3 shows a plot of absorbance spectra for a plurality of QD populations formed using different Ag:Te molar ratios (Ag/Te). Peak absorbance values are also described in Table 1. As shown in FIG. 3 and Table 1, QD population having a Ag:Te molar ratio of 3.4 had a distinct absorbance peak centered at approximately 1150 nm with a peak:valley ratio (p/v) of 1.6. As described herein, the peak:valley ratio (p/v) refers to the ratio of a maximum absorbance value at the absorbance peak, and a minimum absorbance value adjacent to the absorbance peak. Where the absorbance peak is adjacent to two valleys, the peak:valley ratio (p/v) is calculated using the greater absorbance value of the two valleys. QDs were also prepared using Ag:Te molar ratios of 3.2, 3.1, 2.5, and 2.1. QDs having an Ag:Te ratio (Ag/Te) of 3.2 exhibited a wider absorbance peak in the range of 1100-1200 nm than the QDs prepared with an Ag:Te ratio (Ag/Te) of 3.4. The QDs having Ag:Te molar ratios (Ag/Te) of 3.1, 2.5, and 2.1 did not exhibit distinct absorbance peaks in the range of 1100-1200 nm.

In some examples, the IR-absorbing QD 100 has an absorbance peak in the range of 1400 nm-1800 nm, and a peak:valley ratio (p/v) of the absorbance peak is greater than or equal to 1.0. A higher value for the peak:valley ratio (p/v) indicates more infrared absorption. A peak:valley ratio (p/v) of 1.0 or higher is considered to be sufficient for infrared absorption properties. From this perspective, the upper limit of the peak:valley ratio (p/v) is not particularly limited, and may be 10.0 or less, for example. For example, as shown in FIG. 3 and Table 1, the QDs with an Ag:Te molar ratio of 2.5 exhibited an absorbance peak at greater than 1400 nm with a peak:valley ratio (p/v) greater than 1.0. The absorbance peak was redshifted by decreasing the Ag:Te molar ratio (Ag/Te) to 2.1.

Table 1 shows absorbance peak wavelength (Amax), half-width at half maximum (HWHM), and peak:valley ratio (p/v) for QD populations formed using different Ag:Te molar ratios (Ag/Te) (Ag:Te molar ratio is measured by ICP analysis).

TABLE 1

| | Ag:Te mol ratio | | | | |
|---|---|---|---|---|---|
| | 5.8 | 3.7 | 3.1 | 2.4 | 2.1 |
| λmax | 1149 | 1156 | — | 1533 | 1726 |
| HWHM | 118 | 138 | — | 200 | 233 |
| peak:valley | 1.6 | 1.3 | — | 1.1 | 1.2 |
| ratio (p/v) | | | | | |

In some examples, the IR-absorbing QD additionally or alternatively includes another chalcogen. For example, FIG. 4 shows another example of an IR-absorbing QD 108 that further comprises selenium (Se). Like the IR-absorbing QD 100 of FIG. 1, the IR-absorbing QD 108 of FIG. 4 is formed in a two-step seeded growth process, in which the QD seed 102 serves as a foundation to grow the IR-absorbing QD 108. An additional quantity of the chalcogenide precursor 106 of FIG. 1 (e.g., TOPTe) is added to the reaction mixture containing the silver precursor 104 and the QD seeds 102 along with a selenium precursor 110. The selenium precursor 110 may comprise any suitable material. One example of a suitable selenium precursor 110 includes, but is not limited to, diphenyl phosphine selenide (DPPSe). In this manner, the resulting IR-absorbing QD 108 comprises a core including Ag and Te (e.g., in the form of the Ag—Te QD seed 102), and a shell 112 including Ag, Te, and Se (e.g., in the form of Ag—Se—Te).

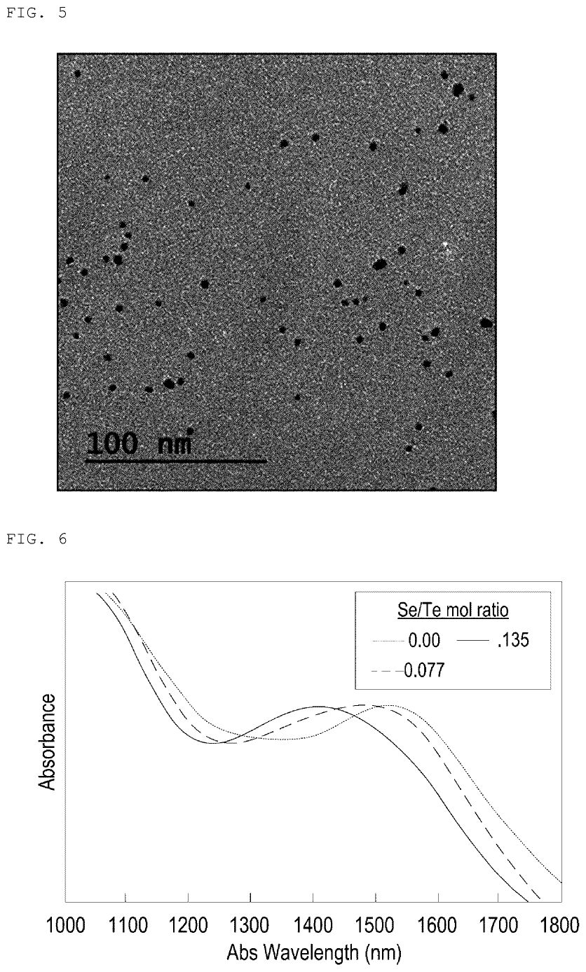

The IR-absorbing QD 108 is grown for up to 1 hour in the reaction mixture. For example, the IR-absorbing QD 108 may be grown for 40 minutes. In other examples, the IR-absorbing QD 108 is grown for greater than 1 hour. In some examples, the IR-absorbing QD 108 is grown at a temperature in the range of 80-200° C. In other examples, the IR-absorbing QD 108 is grown at a temperature in the range of 120-180° C. In yet other examples, the IR-absorbing QD 108 is grown at a temperature in the range of 140-160° C. Growing the IR-absorbing QD 108 from the QD seed 102 enables the IR-absorbing QD 108 to be formed with a distinct absorbance peak (e.g., having a peak:valley ratio (p/v)≥1.0) in the range of 1400 nm-1800 nm. A higher value for the peak:valley ratio (p/v) indicates more infrared absorption. A peak:valley ratio (p/v) of 1.0 or higher is considered to be sufficient for infrared absorption properties. From this perspective, the upper limit of the peak:valley ratio (p/v) is not particularly limited, and may be 10.0 or less, for example. FIG. 5 shows a TEM image of Ag—Se—Te IR-absorbing QDs prepared as described herein.

The selenium precursor 110 is added to achieve a suitable Se:Te molar ratio (Se/Te). In some examples, the IR-absorbing QD 108 is prepared with a Se:Te molar ratio (Se/Te) of greater than 0.00 and no greater than 0.20. In other examples, the Se:Te molar ratio (Se/Te) is in the range of 0.01-0.20. In yet other examples, the Se:Te molar ratio (Se/Te) is in the range of 0.077-0.135. As an example, samples of QDs were prepared with a Se:Te molar ratio (Se/Te) of 0.077 and 0.135. FIG. 6 shows a plot of absorbance spectra for a plurality of QD populations formed using different Se:Te molar ratios (Se/Te). Peak absorbance values are also described in Table 2. In the absence of Se, an absorbance peak was obtained that was centered at 1522 nm. Adding Se blue-shifted the absorbance peak to 1481 nm with a Se:Te molar ratio (Se/Te) of 0.077. When the Se:Te molar ratio (Se/Te) was 0.135, an absorbance peak was obtained that was centered at 1409 nm with a peak:valley ratio (p/v) of 1.2. Thus, Se doping may be used to tune the absorbance of the IR-absorbing QDs. Introducing S in addition to or as an alternative to Se may result in the absorbance becoming more blueshifted relative to the Ag/Te/Se system. In some examples, the absorbance may be blue-shifted further towards 1200 nm by increasing the Se:Te molar ratio (Se/Te) above 0.20. It will also be appreciated that the IR-absorbing QD may be prepared with an Ag—Se shell that does not include Te. In some examples, a shell may comprise ZnS, ZnSe, and/or other suitable material having suitably low environmental and health concerns.

Table 2 shows Amax, HWHM, and peak:valley ratio (p/v) for QD populations formed using different Se:Te molar ratios (Se/Te).

TABLE 2

| | Se:Te mol ratio (Se/Te) | | |
|---|---|---|---|
| | 0 | 0.077 | 0.135 |
| λmax | 1522 | 1481 | 1409 |
| HWHM | 202 | 203 | 237 |
| peak:valley | 1.1 | 1.2 | 1.2 |
| ratio (p/v) | | | |

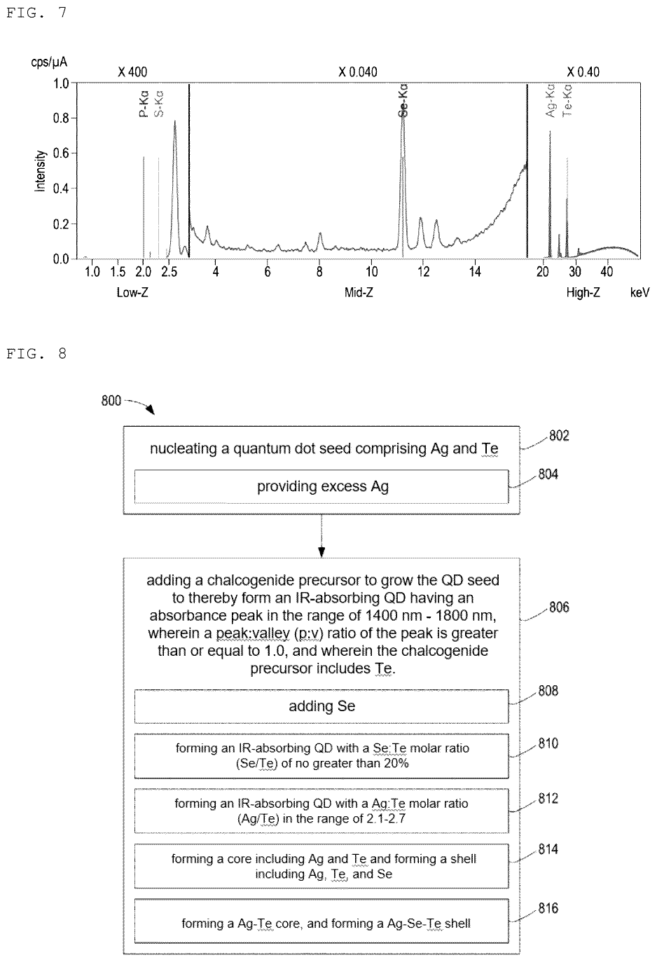

X-ray fluorescence (XRF) analysis also can confirm the presence of Se in the IR-absorbing QD 108. FIG. 7 shows an XRF spectrum obtained for a sample of the IR-absorbing QD 108. The sample was prepared with a Se:Te molar ratio (Se/Te) of 0.135 in tetrachloroethylene (TCE) solvent. This confirms the incorporation of Se into the IR-absorbing QD 108.

Table 3 shows theoretical Se:Te molar ratio (Se/Te) and Se:Te molar ratio (Se/Te) measured via XRF analysis.

TABLE 3
XRF (Se/Te)

| Theoretical | Actual |
|---|---|
| 0.00 | 0 |
| 0.077 | 0.072 |
| 0.135 | 0.147 |

In some examples, the prepared IR-absorbing QDs are dispersible in a nonpolar solvent. For example, the IR-absorbing QDs 100, 108 may be purified from the reaction mixture and re dispersed in the nonpolar solvent. One suitable example of a nonpolar solvent includes, but is not limited to, tetrachloroethylene (TCE).

In other examples, the IR-absorbing QDs are dispersible in a polar solvent. For example, a ligand-exchange reaction may be performed to provide the IR-absorbing QDs with a ligand that renders the quantum dot dispersible in polar solvent. The polar solvent may comprise any suitable solvent. The solvent may have a suitable viscosity and surface tension for inkjet printing. In this manner, the IR-absorbing QDs may be used to fabricate IR-absorbing devices, such as pixels of an IR detector, quickly and cost-effectively.

With reference now to FIG. 8, a flowchart is illustrated depicting an example method 800 for preparing IR-absorbing QDs. The following description of method 800 is provided with reference to the components described above and shown in FIGS. 1-7, and the method steps in method 800 will be described with reference to corresponding portions of FIGS. 1-7 below. It will be appreciated that method 800 also may be performed in other contexts using other suitable hardware and software components.

It will be appreciated that the following description of method 800 is provided by way of example and is not meant to be limiting. It will be understood that various steps of method 800 can be omitted or performed in a different order than described, and that the method 800 can include additional and/or alternative steps relative to those illustrated in FIG. 8 without departing from the scope of this disclosure.

At 802, the method 800 includes nucleating a QD seed comprising Ag and Te. For, example, the QD seed 102 of FIG. 1 is nucleated using a silver precursor 104 and a chalcogenide precursor 106 comprising Te to form Ag—Te QD seeds. The QD seed 102 is used as a foundation to grow the IR-absorbing QD 100 of FIG. 1 and the IR-absorbing QD 108 of FIG. 4.

In some examples, at 804, the method 800 includes providing excess Ag. For example, the QD seed 102 may be nucleated in the presence of excess Ag. Providing excess Ag enables fine control over the size and dispersion of the QD seeds, as well as a stoichiometric ratio of Ag and Te in the QD seeds.

At 806, the method 800 includes adding a chalcogenide precursor to grow the QD seed to thereby form an IR-absorbing QD having an absorbance peak in the range of 1400 nm-1800 nm, wherein a peak:valley ratio (p/v) of the peak is greater than or equal to 1.0, and wherein the chalcogenide precursor includes Te. For example, the IR-absorbing QD 100 of FIG. 1 is produced by adding an additional quantity of the chalcogenide precursor 106 to a reaction mixture including the QD seed 102. Growing the IR-absorbing QD 100 from the QD seed 102 results in an absorbance peak in the range of 1400 nm-1800 nm with a peak:valley ratio (p/v) of the absorbance peak of greater than or equal to 1.0.

In some examples, as indicated at 808 in FIG. 8, adding the chalcogenide precursor further comprises adding Se. For example, the IR-absorbing QD 108 of FIG. 4 is formed by adding the Se precursor 110 to the reaction mixture including the QD seed 102. This results in the incorporation of Se into the IR-absorbing QD 108, as indicated by the XRF of FIG. 7.

At 810, in some examples, the method 800 includes forming the QD with a Se:Te molar ratio (Se/Te) of greater than 0.00 and no greater than 0.20. As described above with reference to FIG. 6, Se doping may be used to tune the absorbance of the IR-absorbing QDs. Utilizing a Se:Te molar ratio (Se/Te) that is less than or equal to 0.20 results in an absorbance peak in the range of 1400 nm-1800 nm with a peak:valley ratio (p/v)≥1.0. A higher value for the peak:valley ratio (p/v) indicates more infrared absorption. A peak:valley ratio (p/v) of 1.0 or higher is considered to be sufficient for infrared absorption properties. From this perspective, the upper limit of the peak:valley ratio (p/v) is not particularly limited, and may be 10.0 or less, for example.

In some examples, at 812, the method 800 includes forming the QD with a Ag:Te molar ratios (Ag/Te) in the range of 2.1-2.7. As described above with reference to FIG. 3, the Ag:Te molar ratios (Ag/Te) may be used to tune the absorbance of the IR-absorbing QDs. Utilizing a Ag:Te molar ratios (Ag/Te) in the range of 2.1-2.7 results in an absorbance peak in the range of 1400 nm-1800 nm with a peak:valley ratio (p/v)≥1.0.

At 814 in the method 800, in some examples, forming the QD comprises forming a core including Ag and Te and forming a shell including Ag, Te, and Se. For example, forming the IR-absorbing QD 108 of FIG. 4 includes forming a core including Ag and Te and forming a shell including Ag, Te, and Se. As indicated at 816, in some examples, forming the core comprises forming a Ag—Te core, and wherein forming the shell comprises forming a Ag—Se—Te shell. For example, the IR-absorbing QD 108 includes a core that takes the form of Ag—Te and a shell in the form of Ag—Se—Te. As described above, this results in an absorbance peak in the range of 1400 nm-1800 nm.

The above-described methods may be used to produce an IR-absorbing QD. The IR-absorbing QD comprises an absorbance peak in the range of 1400 nm-1800 nm. This enables the IR-absorbing QD to detect IR light in the range of 1400 nm-1800 nm (e.g., light emitted by a 1450-nm laser) with a high signal-to-noise ratio. A peak:valley ratio (p/v) of the absorbance peak is greater than or equal to 1.0. This also increases the signal-to-noise ratio relative to the use of a material with a smaller peak:valley ratio (p/v). In addition, the IR-absorbing QD comprises silver and tellurium, and optionally selenium. In this manner, the IR-absorbing QD may be substantially free of heavy metal elements.

Another example provides an infrared-absorbing quantum dot, comprising silver and tellurium, wherein the infrared-absorbing quantum dot comprises an absorbance peak in the range of 1400 nm-1800 nm, and wherein a peak:valley ratio (p/v) of the peak is greater than or equal to 1.0. In some such examples, the infrared-absorbing quantum dot is substantially free of heavy metal elements. In some such examples, the infrared-absorbing quantum dot alternatively or additionally comprises a molar ratio of Ag:Te (Ag/Te) is in the range of 2.1-2.7. In some such examples, the infrared-absorbing quantum dot alternatively or additionally further comprising selenium. In some such examples, the infrared-absorbing quantum dot alternatively or additionally comprises a Se:Te molar ratio (Se/Te) of greater than 0.00 and no greater than 0.20. In some such examples in accordance with an embodiment of the invention, the infrared-absorbing quantum dot alternatively or additionally comprises a core including Ag and Te, and a shell including Ag, Te, and Se. In some such examples, the core alternatively or additionally comprises the form of Ag—Te, and the shell alternatively or additionally comprises the form of Ag—Se—Te. In some such examples, the infrared-absorbing quantum dot alternatively or additionally further comprises a core including Ag and Te, and a shell including Ag and Se. In some such examples, the infrared-absorbing quantum dot alternatively or additionally is dispersible in a nonpolar solvent. In some such examples, the infrared-absorbing quantum dot alternatively or additionally further comprises a ligand that renders the quantum dot dispersible in polar solvent.

Another example provides a method of preparing an infrared-absorbing quantum dot, the method comprising nucleating a quantum dot seed comprising Ag and Te, and adding a chalcogenide precursor to grow the quantum dot seed to thereby form an infrared-absorbing quantum dot having an absorbance peak in the range of 1400 nm-1800 nm, wherein a peak:valley ratio (p/v) of the peak is greater than or equal to 1.0, and wherein the chalcogenide precursor includes Te. In some such examples, adding the chalcogenide precursor further comprises adding Se. In some such examples, the method alternatively or additionally further comprises forming the infrared-absorbing quantum dot with a Se:Te molar ratio (Se/Te) of greater than 0.00 and no greater than 0.20. In some such examples, the method alternatively or additionally comprises providing excess Ag. In some such examples, the method alternatively or additionally comprises forming the infrared-absorbing quantum dot with a molar ratio of Ag:Te (Ag/Te) in the range of 2.1-2.7. In some such examples, forming the infrared-absorbing quantum dot alternatively or additionally comprises forming a core including Ag and Te and forming a shell including Ag, Te, and Se. In some such examples, forming the core alternatively or additionally comprises forming a Ag—Te core, and wherein forming the shell comprises forming a Ag—Se—Te shell.

Another example provides an infrared-absorbing quantum dot, comprising a core including Ag and Te, and a shell including Ag, Te, and Se, wherein the infrared-absorbing quantum dot comprises an absorbance peak in the range of 1400 nm-1800 nm, and wherein a peak:valley ratio (p/v) of the absorbance peak is greater than or equal to 1.0. In some such examples, a molar ratio of Ag:Te (Ag/Te) is in the range of 2.1-2.7. In some such examples, a molar ratio of Se:Te (Se/Te) is greater than 0.00 and no greater than 0.20.

The infrared-absorbing quantum dot and the method of preparing the infrared-absorbing quantum dot in accordance with an embodiment of invention the include the following configurations.
(1) An infrared-absorbing quantum dot, comprising: silver (Ag); and tellurium (Te); wherein the infrared-absorbing quantum dot comprises an absorbance peak in the range of 1400 nm-1800 nm, and wherein a peak:valley ratio (p/v) of the absorbance peak is greater than or equal to 1.0.
(2) The infrared-absorbing quantum dot according to (1) above, wherein the infrared-absorbing quantum dot is substantially free of heavy metal elements.
(3) The infrared-absorbing quantum dot according to (1) or (2) above, wherein a molar ratio of Ag:Te (Ag/Te) is in the range of 2.1-2.7.
(4) The infrared-absorbing quantum dot according to any one of (1) to (3) above, further comprising selenium (Se).
(5) The infrared-absorbing quantum dot according to (4) above, wherein a molar ratio of Se:Te (Se/Te) is greater than 0.00 and no greater than 0.20.
(6) The infrared-absorbing quantum dot according to any one of (1) to (5) above, further comprising a core including Ag and Te, and a shell including Ag, Te, and Se.
(7) The infrared-absorbing quantum dot according to any one of (1) to (5) above, further comprising a core including Ag and Te, and a shell including Ag and Se.
(8) The infrared-absorbing quantum dot according to any one of (1) to (7) above, wherein the infrared-absorbing quantum dot is dispersible in a nonpolar solvent.
(9) The infrared-absorbing quantum dot according to any one of (1) to (7) above, further comprising a ligand that renders the infrared-absorbing quantum dot dispersible in polar solvent.
(10) A method of preparing an infrared-absorbing quantum dot, the method comprising:
Nucleating a quantum dot seed comprising silver (Ag) and tellurium (Te); and
adding a chalcogenide precursor to grow the quantum dot seed to thereby form an infrared-absorbing quantum dot having an absorbance peak in the range of 1400 nm-1800 nm, wherein a peak:valley ratio (p/v) of the peak is greater than or equal to 1.0, and wherein the chalcogenide precursor includes tellurium (Te).
(11) The method of preparing the infrared-absorbing quantum dot according to (10) above, wherein adding the chalcogenide precursor further comprises adding Se.
(12) The method of preparing the infrared-absorbing quantum dot according to (11) above, further comprising forming the infrared-absorbing quantum dot with a molar ratio of Se:Te (Se/Te) of greater than 0.00 and no greater than 0.20.
(13) The method of preparing the infrared-absorbing quantum dot according to any one of (10) to (12) above, further comprising providing excess Ag.
(14) The method of preparing the infrared-absorbing quantum dot according to any one of (10) to (13) above, further comprising forming the infrared-absorbing quantum dot with a molar ratio of Ag:Te (Ag/Te) in the range of 2.1-2.7.
(15) The method of preparing the infrared-absorbing quantum dot according to any one of (11) to (14) above, wherein forming the infrared-absorbing quantum dot comprises forming a core including Ag and Te and forming a shell including Ag, Te, and Se.
(16) An infrared-absorbing quantum dot, comprising:
a core including silver (Ag) and tellurium (Te); and
a shell including silver (Ag), tellurium (Te), and selenium (Se),
wherein the infrared-absorbing quantum dot comprises an absorbance peak in the range of 1400 nm-1800 nm, and wherein a peak:valley ratio (p/v) of the peak is greater than or equal to 1.0.
(17) The infrared-absorbing quantum dot according to (16) above, wherein a molar ratio of Ag:Te (Ag/Te) is in the range of 2.1-2.7.
(18) The infrared-absorbing quantum dot according to (16) or (17) above, wherein a molar ratio of Se:Te (Se/Te) is greater than 0.00 and no greater than 0.20.

It will be understood that the configurations and/or approaches described herein are exemplary in nature, and that these specific embodiments or examples are not to be considered in a limiting sense, because numerous variations are possible. The specific routines or methods described herein may represent one or more of any number of strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

Further, it will be appreciated that the terms “includes,” “including,” “has,” “contains,” variants thereof, and other similar words used in either the detailed description or the claims are intended to be inclusive in a manner similar to the term “comprising” as an open transition word without precluding any additional or other elements.

“And/or” as used herein is defined as the inclusive or V, as specified by the following truth table:

TABLE 4

| A | B | A ∨ B |
|---|---|---|
| TRUE | TRUE | TRUE |
| TRUE | FALSE | TRUE |
| FALSE | TRUE | TRUE |
| FALSE | FALSE | FALSE |

### EXAMPLES

The following paragraphs describe examples of IR-absorbing QDs prepared as described herein and comparative examples of QDs. Table 5 summarizes the composition and optical properties (A max, HWHM, and P: V) of each population of QDs.

TABLE 5

| | Element | Ag/Te | Se/Te | λmax | HWHM | p/v |
|---|---|---|---|---|---|---|
| Ex. 1 | Ag, Te | 2.4 | — | 1553 | 200 | 1.2 |
| Ex. 2 | Ag, Te | 2.4 | — | 1522 | 202 | 1.1 |
| Ex. 3 | Ag, Te | 2.1 | — | 1726 | 233 | 1.1 |
| Ex. 4 | Ag, Te, Se | 2.56 | 0.077 | 1481 | 203 | 1.2 |
| Ex. 5 | Ag, Te, Se | 2.70 | 0.135 | 1409 | 237 | 1.2 |
| Comp Ex. 1 | Ag, Te | 5.8 | — | 1149 | 118 | 1.6 |
| Comp Ex. 2 | Ag, Te | 3.7 | — | 1156 | 138 | 1.3 |
| Comp Ex. 3 | Ag, Te | 3.1 | — | — | — | 0 |
| Comp Ex. 4 | Ag, Se | — | — | 960 | 130 | 2.3 |
| Comp Ex. 5 | Ag, S | — | — | 800 | 72 | 4.3 |

### [Example 1]-[Example 3]

Ag—Te QD seeds were nucleated by a hot injection method as described above. Specifically, TOPTe was injected at 150° C. to a solution of Ag (acetate) mixed with octanethiol. The temperature was maintained at 150° C. for 40 minutes before the reaction mixture was cooled to ambient temperature. The Ag:Te molar ratio at the time of the preparation was 5.8. The resulting QD seeds exhibited an absorbance peak at 1150 nm with a peak:valley ratio (p/v) of 1.6.

The IR-absorbing QDs of example 1 were prepared using the synthesized Ag—Te QD seeds. Growth of the IR-absorbing QDs proceeded by adding TOPTe at 150° C. for another 40 minutes to adjust the Ag:Te molar ratio. The IR-absorbing QDs were purified using acetone as an antisolvent and precipitated via centrifugation. The IR-absorbing QDS were then collected, redispersed in TCE, and centrifuged again to remove any undissolved particles. The IR-absorbing QDs were then analyzed using an ultraviolet-visible-near-infrared (UV-Vis-NIR) spectrophotometer. In addition, the resulting IR-absorbing QDs were subjected to elemental analysis.

The elemental analysis was performed as follows. First, 0.05 g to 0.2 g of IR-absorbing QDs in an organic solvent were mixed with 10 mL of concentrated nitric acid and kept at 200° C. for 15 minutes. Then, after decomposing the IR-absorbing QDs using a microwave decomposer (CEM Mars6), the sample was diluted to 50 mL with deionized water to obtain a sample for elemental analysis. Further the sample was analyzed using ICP-OES (Agilent 5800) with external calibration curves with commercially available certified elemental standards. At this time, internal standards were used with calibration standards and samples to correct for instrument drift.

In examples 1 and 2, the IR-absorbing QDs were prepared using a Ag:Te molar ratio of 2.4. This resulted in an absorbance peak with a peak:valley ratio (p/v) over 1.0 at wavelengths longer than 1500 nm.

In example 3, the absorbance peak was redshifted to 1726 nm by decreasing the Ag:Te molar ratio to 2.1.

### [Example 4] and [Example 5]

The IR-absorbing QDs of examples 4 and 5 were prepared using Ag—Te QD seeds synthesized as described above regarding example 1. Specifically, a mixture of TOPTe and DPPSe was injected into a mixture of the Ag—Te QD seeds at 150° C. The mixture of TOPTe and DPPSe had a Se:Te molar ratio of 0.077 in example 5 and a Se:Te (Se/Te) molar ratio of 0.135 in example 6. The temperature of the mixture was maintained for 40 minutes to form a shell of Ag—Se—Te (Te doped with Se) over the Ag—Te QD seeds. The mixture was then cooled to ambient temperature and the IR-absorbing QDs were purified and characterized as described above. In example 4 (Se/Te=0.077), an absorbance peak was observed at 1481 nm with a peak:valley ratio (p/v) over 1.2. The absorbance peak was blueshifted to 1409 nm in example 6 by increasing the molar ratio of Se/Te (Se/Te) to 0.135.

### Comparative Example 1

In comparative example 1, Ag—Te IR-absorbing QDs were prepared with a Ag:Te molar ratio of 3.4. The IR-absorbing QDs in comparative example 1 had an absorbance peak at 1149 nm with a peak:valley ratio (p/v) of 1.6, similar to the Ag—Te QD seeds described above.

### Comparative Example 2

The Ag:Te molar ratio (Ag/Te) was decreased to 3.2 in comparative example 2. This resulted in a similar absorbance peak to comparative example 1 located at 1156 nm, but with a smaller peak:valley ratio (p/v) of 1.3.

### Comparative Example 3

In comparative example, 3, no discernable absorbance peaks were observed when the Ag:Te molar ratio (Ag/Te) was decreased to 3.1.

### Comparative Example 4

In comparative example 4, Ag—Se QDs were prepared as described above using DPPSe instead of TOPTe. The resulting Ag—Se QDs had an absorbance peak at 960 nm.

### Comparative Example 5

Ag—S QDs were prepared in comparative example 5 were blue-shifted relative to the Ag—Se QDs in comparative example 4, with an absorbance peak at 800 nm.
100 infrared-absorbing quantum dot
102 quantum dot seed
104 silver precursor
106 chalcogenide precursor
108 infrared-absorbing quantum dot
110 selenium precursor
112 shell

1. An infrared-absorbing quantum dot, comprising: silver (Ag); and tellurium (Te); wherein the infrared-absorbing quantum dot comprises an absorbance peak in the range of 1400 nm-1800 nm, and wherein a peak:valley ratio (p/v) of the absorbance peak is greater than or equal to 1.0.

2. The infrared-absorbing quantum dot according to claim 1, wherein the infrared-absorbing quantum dot is substantially free of heavy metal elements.

3. The infrared-absorbing quantum dot according to claim 1, wherein a molar ratio of Ag:Te (Ag/Te) is in the range of 2.1-2.7.

4. The infrared-absorbing quantum dot according to claim 1, further comprising selenium (Se).

5. The infrared-absorbing quantum dot according to claim 4, wherein a molar ratio of Se:Te (Se/Te) is greater than 0.00 and no greater than 0.20.

6. The infrared-absorbing quantum dot according to claim 1, further comprising a core including Ag and Te, and a shell including Ag, Te, and Se.

7. The infrared-absorbing quantum dot according to claim 1, further comprising a core including Ag and Te, and a shell including Ag and Se.

8. The infrared-absorbing quantum dot according to claim 1, wherein the infrared-absorbing quantum dot is dispersible in a nonpolar solvent.

9. The infrared-absorbing quantum dot according to claim 1, further comprising a ligand that renders the infrared-absorbing quantum dot dispersible in polar solvent.

10. A method of preparing an infrared-absorbing quantum dot, the method comprising:
Nucleating a quantum dot seed comprising silver (Ag) and tellurium (Te); and
adding a chalcogenide precursor to grow the quantum dot seed to thereby form an infrared-absorbing quantum dot having an absorbance peak in the range of 1400 nm-1800 nm, wherein a peak:valley ratio (p/v) of the peak is greater than or equal to 1.0, and wherein the chalcogenide precursor includes tellurium (Te).

11. The method of preparing the infrared-absorbing quantum dot according to claim 10, wherein adding the chalcogenide precursor further comprises adding selenium (Se).

12. The method of preparing the infrared-absorbing quantum dot according to claim 11, further comprising forming the infrared-absorbing quantum dot with a molar ratio of Se:Te (Se/Te) of greater than 0.00 and no greater than 0.20.

13. The method of preparing the infrared-absorbing quantum dot according to claim 10, further comprising providing excess Ag.

14. The method of preparing the infrared-absorbing quantum dot according to claim 10, further comprising forming the infrared-absorbing quantum dot with a molar ratio of Ag:Te (Ag/Te) in the range of 2.1-2.7.

15. The method of preparing the infrared-absorbing quantum dot according to claim 11, wherein forming the infrared-absorbing quantum dot comprises forming a core including Ag and Te and forming a shell including Ag, Te, and Se.

16. An infrared-absorbing quantum dot, comprising:
a core including silver (Ag) and tellurium (Te); and
a shell including silver (Ag), tellurium (Te), and selenium (Se),
wherein the infrared-absorbing quantum dot comprises an absorbance peak in the range of 1400 nm-1800 nm, and wherein a peak:valley ratio (p/v) of the peak is greater than or equal to 1.0.

17. The infrared-absorbing quantum dot according to claim 16, wherein a molar ratio of Ag:Te (Ag/Te) is in the range of 2.1-2.7.

18. The infrared-absorbing quantum dot according to claim 16, wherein a molar ratio of Se:Te (Se/Te) is greater than 0.00 and no greater than 0.20.

19. The infrared-absorbing quantum dot according to claim 4, wherein the infrared-absorbing quantum dot is substantially free of heavy metal elements.

20. The infrared-absorbing quantum dot according to claim 4, wherein a molar ratio of Ag:Te (Ag/Te) is in the range of 2.1-2.7.
